(19) United States
(12) Patent Application Publication
(10) Pub. No.: US 2002/0039182 A1
(43) Pub. Date: Apr. 4, 2002

(54) Electrical circuit conductor inspection

(75) Inventors: Nissim Savareigo, Ashdod (IL); Igor Markov, Hod Hasharon (IL)

Correspondence Address: SUGHRUE, MION, ZINN, MACPEAK & SEAS, PLLC, 2100 Pennsylvania Avenue, NW, Washington, DC, 20037-3213, US

(73) Assignee: ORBOTECH, LTD.

(21) Appl. No.: 09/939,682

(22) Filed: Aug. 28, 2001

Related U.S. Application Data
(60) Provisional application No. 60/237,803, filed on Oct. 4, 2000.

(51) Int. Cl. G01N 21/00

(52) U.S. Cl. 356/237.5

(57) ABSTRACT

Surface dimension and footprint dimension values are determined by scanning a printed circuit board with a laser. Exposed substrate parts of the printed circuit board fluoresce significantly, emitting detectable luminance, while conductors do not. Conductors reflect the laser light much more strongly than the exposed substrate, especially at the substantially flat part of the top surface. Luminescence and reflectivity collectors provide signals indicative of the footprint and surface dimensions. This cross-sectional information is used in making adjustment determinations in the manufacturing process, and also decisions relating to repair or discard operations.

### CROSS-REFERENCE TO RELATED APPLICATIONS

This application claims the benefit of U.S. Provisional Application No. 60/237,803, filed Oct. 4, 2000. Application Ser. No. 60/237,803 is incorporated herein by reference in its entirety.

### FIELD OF THE INVENTION

This description generally relates to the field of electrical circuit inspection. More particularly, the field of interest involves systems and methods for fabricating and inspecting electrical circuit conductors in electrical circuits.

### BACKGROUND OF THE INVENTION

The production of printed circuit boards is an expensive undertaking, and many extraordinary measures are routinely taken to ensure the highest possible production quality. Automated optical inspection (AOI) harnesses the power, speed, and reliability of computer technology to assist with the task of inspection of printed circuit boards for defects. Existing automated optical inspection (AOI) systems, such as the PC-14 Micro™ and Blaser™ AOI systems, are available from Orbotech of Yavne, Israel.

Existing AOI systems that just inspect conductor width, however, do not provide information for evaluating the cross-section of the conductors.

As used herein, the term “printed circuit board” will be understood to refer in general to any electrical circuit on any substrate, including printed circuit boards, multi-chip modules, ball grid array substrates, integrated circuits and other suitable electrical circuits.

### SUMMARY OF THE INVENTION

A general aspect of the present invention relates to employing a combination of inspection inputs or attributes for the width of a conductor along a top surface and for the width of a conductor along a bottom surface thereof to determine an inspection attribute that may indicate the presence of a defect in a conductor or in a manufacturing process used to fabricate an electrical circuit.

A more particular aspect of the present invention relates to an automated optical inspection system operative to inspect electrical circuits to determine the width of a top surface of conductors forming the circuit at a multiplicity of locations, the width of a bottom surface of conductors forming the circuit at a multiplicity of locations, and the slope of the side walls of conductors, or other defects in the shape of conductor side walls, forming the circuit at a multiplicity of locations.

Another more particular aspect of the present invention relates to a system and method for optically inspecting electrical circuits and calculating therefrom impedance values for conductors forming the electrical circuit.

Another more particular aspect of the present invention relates to a method of producing printed circuit boards, whereby production and/or fabrication process control decisions (such as whether a defect exists in a conductor or in a manufacturing process) are based on inspection outputs indicative of the conductor dimension along the top surface and bottom surface respectively, or the slope of the sides of conductors.

The above and other aspects of the invention are achieved by a system, described in detail below, in which a laser scanner is provided to scan a laser beam across an electrical circuit being inspected. The laser produces a beam which has sufficient energy to cause fluorescence (also referred to herein as luminescence) of the substrate on which conductors are formed. In addition, the beam is reflected by copper conductors which typically have a higher work function than the substrate and do not fluoresce under illumination of the laser beam. The reflected and fluorescent light is collected and the respective intensities of the reflective and fluorescent light are analyzed. Fluorescent light provides an indication of the width of a conductor along its bottom surface, while the reflected light (another attribute) provides an indication of the width of the conductor along its top surface. Comparison of the respective widths of the bottom surfaces and top surfaces of the conductors provides an indication of the slope of the side-walls of a conductor.

The top and bottom dimensions can be used in combination to provide an inspection attribute for a single point or at various sampling points along the length of conductors, and can be used for various analyses of characteristics of the electrical circuit. For example, information about the slope of the side walls of conductors may be used to calculate a cross sectional dimension of an electrical circuit at various sampling points which can be used to derive an impedance value for a conductor. Additionally, statistical information about uniformity in the respect widths of conductors along their top and bottom surfaces may be used to indicate various flaws in etching processes.

The above and other aspects of the invention will be more fully understood and appreciated when read in the light of the detailed description provided below, and the enclosed drawings.

### BRIEF DESCRIPTION OF THE DRAWINGS

FIG. 1 is a functional block diagram of an automated optical inspection system operative to inspect electrical circuits for defects in accordance with a preferred embodiment of the present invention.

FIG. 2 is a simplified representation of a conductor on a substrate, shown in cross-section.

FIG. 3 shows a signal generated in correspondence to an amount of detected luminescent light generated when the conductor and substrate of FIG. 2 are scanned with a laser.

FIG. 4 shows a signal generated in correspondence to an amount of detected reflective light generated as in FIG. 3.

FIG. 5 is a report of distribution of top surface and bottom surface dimension of conductors in an electrical circuit in accordance with a preferred embodiment of the present invention.

FIG. 6 shows, in highly simplified schematic form, a system for manufacturing electrical circuits according to an embodiment of the invention.

FIG. 7 is a flow diagram for explaining the processing of the system shown in FIG. 6.

FIG. 8 shows, in highly simplified schematic form, another system for manufacturing electrical circuits according to an embodiment of the invention.

FIG. 9 is a flow diagram for explaining the processing of the system shown in FIG. 8.

### DETAILED DESCRIPTION OF PREFERRED EMBODIMENTS

Using the above-identified figures, the invention will now be described with respect to various embodiments of the invention. Although many specificities will be mentioned, it must be emphasized that the scope of the invention is not be taken to be that of only the embodiments described herein, but should be construed in accordance with the claims appended below.

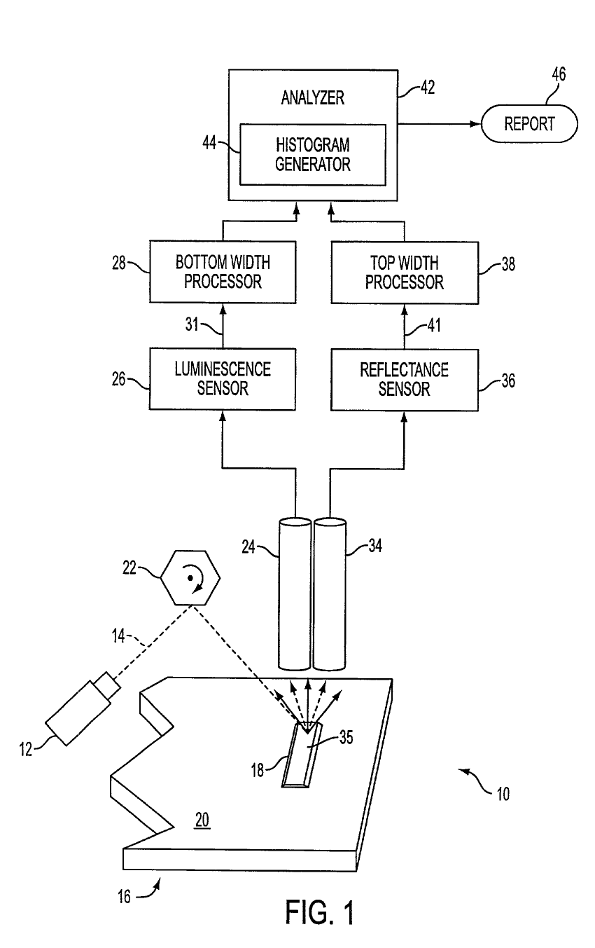

In FIG. 1, automated optical inspection system 10 is operative to inspect electrical circuits for defects in accordance with an embodiment of the present invention.

AOI system 10 suitably is a V-300 automated optical inspection system available from Orbotech Ltd., of Yavne Israel. In FIG. 1, reference numeral 12 indicates a source of radiant energy; reference numeral 14 indicates a beam of radiant energy; reference numeral 16 indicates a portion of a printed circuit board substrate under inspection; reference numeral 18 indicates a conductor; reference numeral 20 indicates a substrate on which the conductor 18 is disposed; reference numeral 22 indicates a device such as a rotating polygonal mirror that scans the beam 14 across the printed circuit board 16; reference numeral 24 indicates a luminescence (also referred to herein as fluorescence) collector; and reference numeral 34 indicates a reflectance collector.

Operation of certain aspects of system 10 are described in U.S. Pat. No. 5,216,479, and are readily grasped by those familiar with this field. Thus, a highly detailed description of the operation of AOI system 10 is omitted here in favor of a brief overview.

The source of radiant energy 12 may be a laser, such as any suitable CW or solid state laser, and preferably is a He:Cd laser, available from Kimmon Electric Company of Japan, producing coherent light in the blue spectrum, at about 442 nm. Substrate 20 may, e.g., be a fiberglass or organic substrate.

The beam 14 is scanned across the circuit portion 16, and the collectors 24 and 34 are kept operationally positioned to collect their respective types of light at the point at which the beam 14 impinges on the circuit portion 16. To this end, it is convenient if the collectors 24 and 34 are linear in a main scanning direction of the beam 14, although this is not essential. The collectors 24 and 34 are shown in FIG. 1, in highly simplified form, as point collectors instead of linear collectors for the sake of ease of illustration.

It will be appreciated that the collectors, sensors, and processors mentioned above may together be thought of as an inspection functionality.

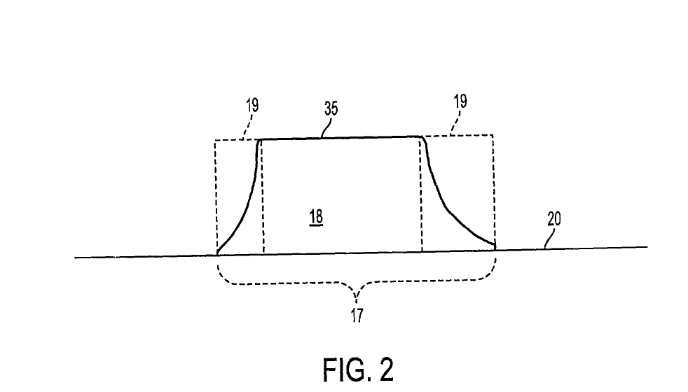

FIG. 2 shows a cross section of a conductor 18 on a substrate 20. Reference numeral 35 indicates an upper, substantially flat surface of conductor 18. The upper surface 35 of conductor 18 has shoulders 19 on either side of it, sloping down in some shape to the substrate 20. Reference numeral 17 indicates a lower, bottom surface of conductor 18.

The width of conductor 18 at its top surface 35 may be referred to hereinafter as a top surface width, or top width, or also a surface dimension.

The width of conductor 18 at its bottom surface 17 may be referred to hereinafter as a bottom surface width, or bottom width, or also as a footprint dimension.

When the spot of beam 14 impinges on the substrate 20 at a location free of conductor 18, a localized part of the substrate fluoresces, giving off luminescent light collected by luminescence collector 24 and sensed by luminescence sensor 26. At such a location, the reflected light given off by substrate 20 is very low because substrate 20 tends to diffuse the light, and a substantially zero value is output by reflectance sensor 36.

When the spot of beam 14 impinges on the substrate 20 at a location where a conductor 18 is present, the conductor does not fluoresce because the work function of the conductor 18 is greater than required to release a photon, due to the quantum effect of illumination by beam 14. Thus, luminescence sensor 26 outputs a substantially zero value. Conductor 18, however, is relatively reflective. Reflectance collector 34 therefore collects reflectance and reflectance sensor 36 outputs a value above zero at such a point.

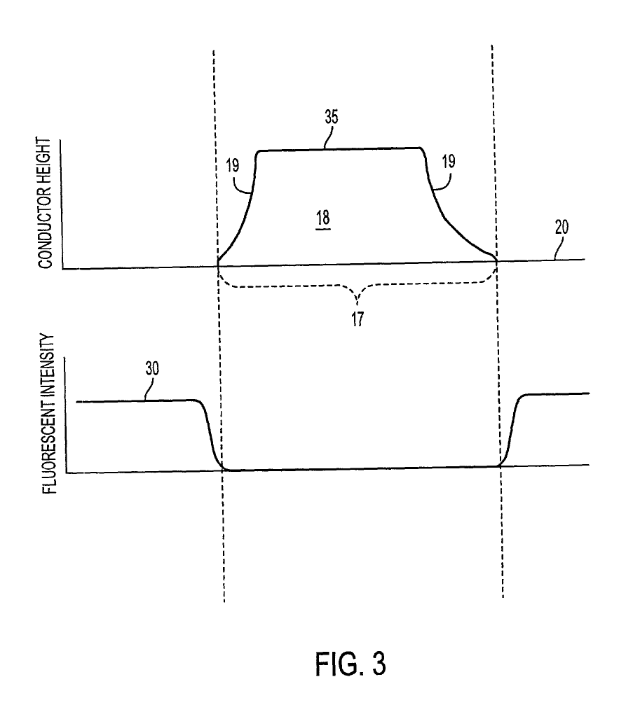

FIG. 3 shows a luminescence signal 30 produced by luminescence sensor 26, indicative of an amount of luminescence emitted by the surface as a beam spot scans over the cross-section of conductor 18 shown. When the beam spot is over the substrate only, the luminescence has a non-zero value. As the spot begins to cross from the exposed substrate to the shoulder portion 19 of the conductor 18, the detected luminescence decreases rapidly. It will be appreciated that, in the example shown, the beam spot has a finite width, and so as it moves to the shoulder portion 19 from the exposed substrate, the amount of exposed substrate being impinged upon by the beam spot decreases to zero, as does the amount of detectable luminescence. It will also be appreciated that the inspection is not strictly limited to only the conductor itself, but includes also the exposed substrate in the area. The conductor and the exposed substrate in the area may be referred to, for linguistic convenience, as a “conductor location, ” and a conductor location may comprise several pixels in the digital map 31.

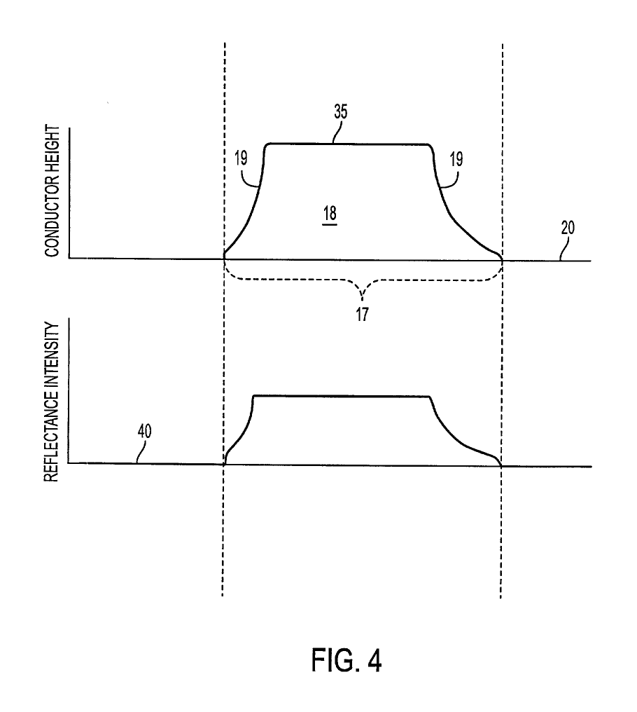

FIG. 4 shows a reflectance signal 40 output by reflectance sensor 36, indicative of an amount of reflectance emitted by the surface as a beam spot scans over the cross-section of conductor 18 shown. When the beam spot is over the substrate only, the reflectance has a substantially zero value. As the spot begins to cross from the exposed substrate to the shoulder portion 19 of the conductor 18, the detected reflectance increases. Depending on the angle of incidence, the reflectance may reach a maximum value when the spot is impinging on only the top surface 35, as shown in FIG. 4. When the spot begins to move from the top surface 35 to the shoulder portion 19, the amount of reflectance that is collected by the reflectance collector 34 decreases quickly, but is greater than zero. This is because the angle of the shoulder portion 19 tends to reflect some of the light in a direction away from the reflectance collector 34.

In operation, the sensor 26 may include analogue to digital circuitry processing luminance signal 30 to produce a digital image or map 31 (FIG. 1) of luminance values at selected locations on the surface of substrate 20. Digital image 31 is supplied to bottom width processor 28. Likewise, the reflectance sensor 36 may include analogue to digital circuitry processing reflectance signal 40, to produce a digital image or map 41 (FIG. 1) of reflectance values at selected locations on the surface of substrate 20.

The bottom width processor 28 calculates a footprint dimension of one or more conductors 18 at selected conductor locations therealong. This footprint dimension, as can be seen from FIG. 1, is based on the luminance signal 30. The top width processor 38 calculates a top surface dimension of one or more conductors 18 at selected conductor locations therealong. This top surface dimension, as can be seen from FIG. 1, is based on the reflectance signal 30.

The respective outputs of bottom width processor 28 and top width processor 38 may be thought of as different attributes of the conductor, and are provided to an analyzer 42, which may be operative on several modes. In one mode of operation, analyzer 42 calculates a cross section configuration of conductors based on the respective width dimensions measured for the top surface 35 and bottom surface 32 respectively of conductors 18. Analyzer 42 may also be thought of as an attribute analyzer

In another mode of operation, analyzer 42 derives the slope of side walls of conductors 18, at one or more locations along a conductor, from the respective top surface width and bottom surface widths of conductors 18 at those locations.

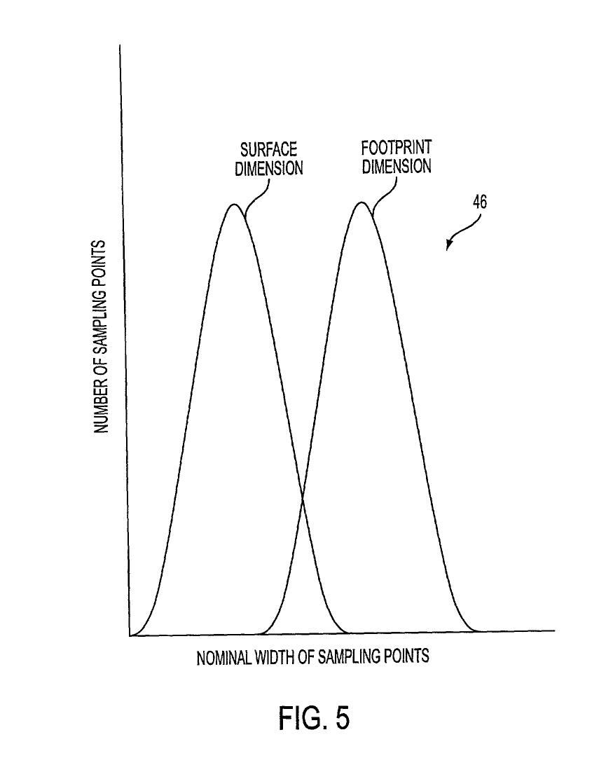

In another mode of operation, analyzer 42 analyzes a distribution of top surface widths and of bottom surface widths of conductors disposed along all or part of the surface of substrate 20. Analysis of the distribution of top widths and bottom widths provides information which can be used to control etching processes. In a system configuration enabling this mode of operation, a histogram generator 44 may be included in cross section configuration analyzer 42. Reference is made to FIG. 5 which is a pictorial illustration of a report of the distribution of top surface and bottom surface dimensions of conductors in an electrical circuit in accordance with an embodiment of the present invention.

As seen in FIG. 5, histogram generator 44 produces a statistical report of the respective width distribution of top surfaces and bottom surfaces for predetermined sampling points along selected conductors. From the histogram, an average top surface width and an average bottom surface width may be determined, along with other useful statistical calculations. These calculations, and the difference between the top and bottom dimensions, are indicative of a shape of conductors, including a slope of conductor side walls. It will be appreciated that information relating to the shape of conductors is useful for understanding and improving photo-lithography and/or etching processes that are employed in manufacturing printed circuit boards.

Moreover, information relating to the shape of conductors may be employed, for example, to calculate a nominal impedance of conductors. The nominal impedance may be calculated in a manner that will be readily grasped, since impedance is a function of the cross sectional dimension of a conductor.

The cross sectional shape of the conductor can be approximated in various ways, once the surface and footprint dimensions have been determined. For example, it could be assumed that the shoulders were constituted by straight lines, and that the cross sectional shape was a trapezoid. Thus, the cross sectional area of the conductor (and hence, impedance) could be computed in a simplified manner.

Another use of information relating to the cross sectional shape of conductors is to control photolithography and/or etching processes in order to obtain conductors having an optimized shape. Ideally, the top surface dimension 35 of conductors 18 should be slightly smaller than the bottom surface dimension 17 in order to maximize the usage of space along the surface of a printed circuit board substrate 20. Thus if the distribution of top surface width dimensions is too small relative to the distribution of bottom surface width dimensions, then impedance problems are likely to occur since statistically some portions of conductors are likely to have an insufficient volume for efficiently carrying charge. Conversely, if the distribution of top surface width dimensions of conductors is too close relative to the distribution of bottom surface width dimensions, then shoulders 19 (FIG. 2) will typically be bowed inwardly in an exaggerated manner and there will be a high likelihood of cuts along conductors.

It is thus appreciated that analysis of a width distribution report of top width dimensions and bottom width dimensions, as seen in FIG. 5, is useful in adjusting photolithography and/or etching processes in order to optimize the relative dimensions of top and bottom surfaces of conductors 18.

It will be appreciated that the report shown in FIG. 5 is just one possible example of a report 46 that may be generated by the cross section configuration analyzer 42. For example, a report 46 may include an indication of top and bottom width dimensions of conductors at various locations along a conductor.

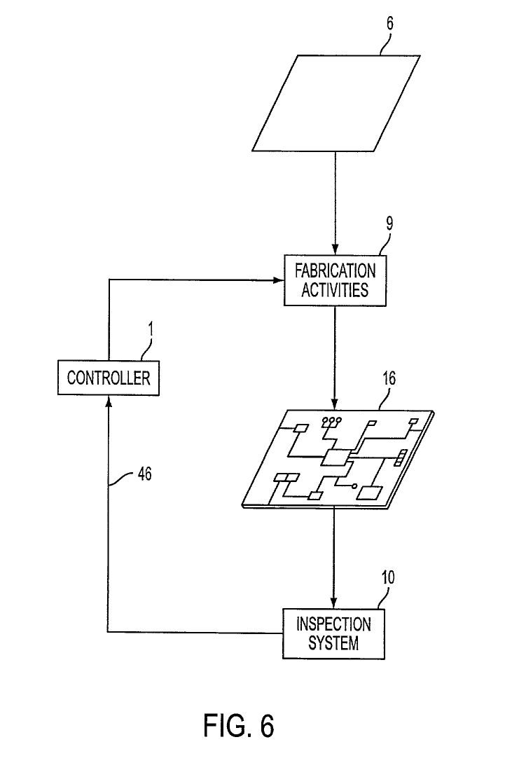

FIG. 6 shows a fabrication and inspection system, in which a controller 1 controls fabrication activities 9 that produce a printed circuit board 16 from input materials 6. The printed circuit board 16 is input to the inspection system 10. The report 46 is provided in a feedback loop to the controller 1. The report 46 may include surface dimension information, and footprint dimension information. The surface dimension information and footprint dimension information may be thought of as a kind of cross-section information. Based on the cross-section information provided to the controller, the controller may, through an automatic or manual process, adjust the assembly activities 9 in response thereto. That is to say, the controller may cause equipment used during fabrication activities 9 to be adjusted, so that the assembly activities are performed in a manner that is projected to produce another printed circuit board 16 with more desirable inspection results.

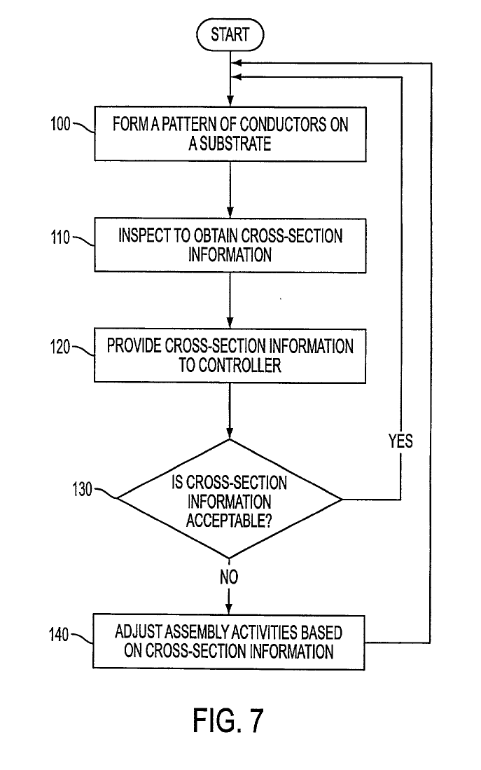

FIG. 7 shows a flow diagram that illustrates the steps just described. In particular, in step 100, a conductor is formed on a substrate. At least one conductor is formed, but as many as necessary are formed during assembly activities 9 to produce the desired printed circuit board 16. The printed circuit board 16 is provided to the inspection system 10. In step 110, the printed circuit board 16 is inspected to determine the cross-section information (i.e., the surface dimension and the footprint dimension, and any other cross-section information that may be desired).

The report 46 is produced, containing cross-section information, and provided to the controller 1 in step 120. In step 130, the controller determines whether the cross-section information is acceptable. That is to say, the controller determines whether the cross-section information indicates a problem that needs correction, or does not indicate such a problem. If there is a problem that needs correction, processing continues from step 130 to step 140, in which the controller adjusts the assembly activities based on the cross-section information prior to resuming production at step 100. If there is not a problem that needs correction, processing may continue from step 130 to step 100, and production may continue as before.

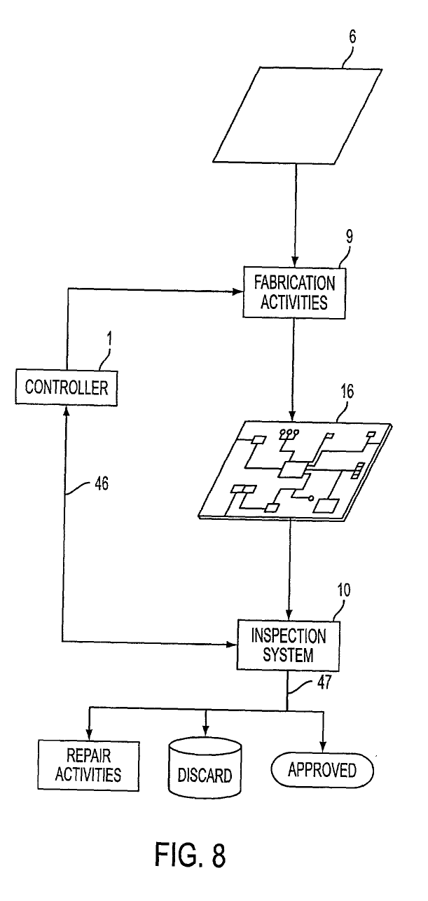

FIG. 8 shows another method of manufacturing electrical circuits, and is similar in many ways to the method illustrated in FIG. 6 except that the report 46 provided by the inspection system 10 is used to determine whether to undertake repair activities, to discard the printed circuit board, or to approve the printed circuit board. It will be appreciated that in this mode of operation, inspection system 10 typically provides an inspection report 47 containing inspection data correlated to specific locations on an inspected printed circuit board substrate 20. This enables a decision making process that facilitates further automatic or manual inspection of defective locations, and ultimately the repair of those defective portions of the printed circuit board substrate 20 which are deemed repairable.

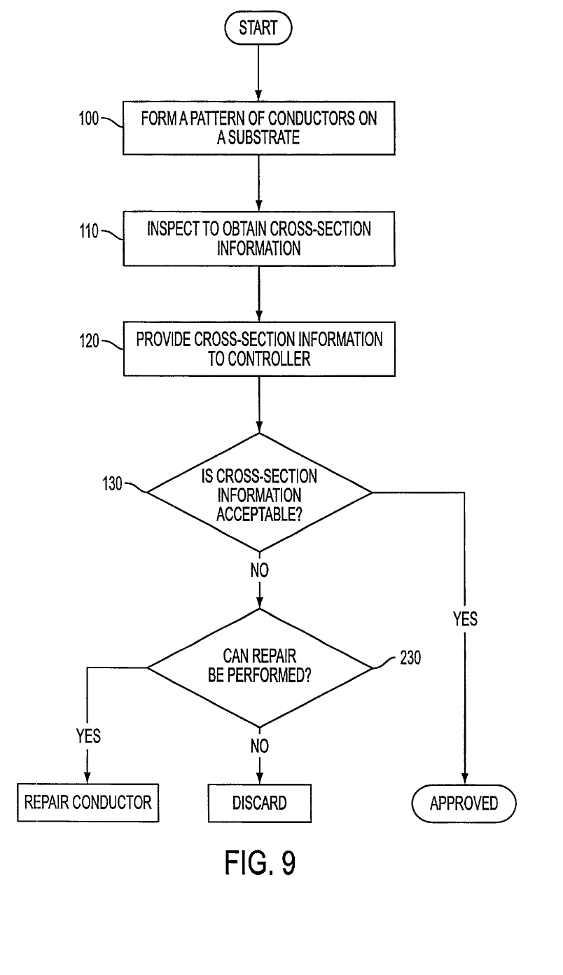

FIG. 9 is a flow diagram that illustrates the steps just mentioned. In particular, steps 100-120 are the same as mentioned above with respect to FIG. 7. In step 130, however, if the cross-section information is acceptable, the printed circuit board 16 is approved. On the other hand, if the cross-section information is not deemed to be acceptable in step 130, processing continues to step 230 in which it is determined whether repair can or cannot be performed. If it is determined that repair can be performed, then processing continues with the printed circuit board 16 being repaired in the step indicated as “repair conductor”. If it is determined that repair cannot be performed, then the printed circuit board 16 is discarded.

Another way of saying this, is that the circuit is discarded or repaired in response to a determination based on the cross sectional information.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

There is claimed:

1. An electrical circuit inspection apparatus comprising:
a first inspection functionality operative to obtain first attribute information with respect to a conductor location on an electrical circuit;
a second inspection functionality operative to obtain second attribute information with respect to said conductor location on said electrical circuit; and
a conductor attribute analyzer receiving said first attribute information and said second attribute information, and evaluating a combination of said first attribute information and said second attribute information to determine an inspection attribute of a conductor at said conductor location.

2. The electrical circuit inspection apparatus according to claim 1, wherein said first inspection functionality senses reflectivity at said conductor location as a basis for said first attribute information.

3. The electrical circuit inspection apparatus according to claim 2, wherein said first inspection functionality determines a top width dimension of said conductor based on said sensed reflectivity.

4. The electrical circuit inspection apparatus according to claim 1, wherein said second inspection functionality senses luminescence at said conductor location as a basis for said second attribute information.

5. The electrical circuit inspection apparatus according to claim 4, wherein said second inspection functionality determines a bottom width dimension of said conductor based on said sensed luminescence.

6. The electrical circuit inspection apparatus according to claim 3, wherein said second inspection functionality senses luminescence at said conductor location as a basis for said second attribute information.

7. The electrical circuit inspection apparatus according to claim 6, wherein said second inspection functionality determines a bottom width dimension of said conductor based on said sensed luminescence.

8. The electrical circuit inspection apparatus according to claim 7, wherein said inspection attribute is a cross section configuration of said conductor.

9. The electrical circuit inspection apparatus according claim 7, wherein said attribute analyzer comprises an impedance analyzer receiving said top width dimension and said bottom width dimension for a plurality of conductor locations, and determining therefrom an impedance attribute of said conductor.

10. An electrical circuit inspection method comprising:
obtaining first attribute information of a plurality of conductor locations on an electrical circuit;
obtaining second attribute information of said plurality of locations; and
determining an inspection attribute of a conductor at one or more of said conductor locations based on a combination of said first attribute information and said second attribute information.

11. The electrical circuit inspection method according to claim 10, wherein said providing of said first attribute information comprises sensing a reflectivity value.

12. The electrical circuit inspection method according to claim 11, wherein said providing of said first attribute information further comprises:
receiving said reflectivity value, for said one or more conductor locations; and
determining therefrom a top width dimension of said conductor.

13. The electrical circuit inspection method according to claim 10, wherein said providing of said second attribute information comprises sensing a luminescence value.

14. The electrical circuit inspection method according to claim 13, wherein said providing of said second attribute information further comprises:
receiving said luminescence value for said one or more conductor locations; and
determining therefrom a bottom width dimension of said conductor.

15. The electrical circuit inspection method to claim 12, wherein said providing of said second attribute information comprises sensing a luminescence value.

16. The electrical circuit inspection method according to claim 15, wherein said providing of said second attribute information further comprises:
receiving said luminescence value for said one or more conductor locations; and
determining therefrom a bottom width dimension of said conductor.

17. The electrical circuit inspection method according to claim 16, further comprising determining, as said inspection attribute, a cross section configuration of said conductor based on said top width dimension and said bottom width dimension.

18. The electrical circuit inspection method according claim 16, further comprising determining, as said inspection attribute, an impedance attribute of said conductor, based on said top width dimension and said bottom width dimension for said one or more conductor locations.

19. The electrical circuit inspection method according claim 1, further comprising employing said inspection attribute to determine a defect in a process used to fabricate said electrical circuit.

20. Electrical circuit inspection apparatus comprising:
at least one inspection functionality operative to provide information regarding a cross-sectional configuration of a conductor; and
an impedance calculator operative to employ said information regarding said cross-sectional configuration of said conductor in order to provide output data indicative of the impedance of said conductor.

21. Electrical circuit inspection apparatus according to claim 20 and wherein said at least one inspection functionality comprises:
a reflection sensor operative to sense reflectivity of said conductor; and
a luminescence sensor operative to sense luminescence of said conductor.

22. Electrical circuit inspection apparatus comprising:
a top dimension calculator operative to calculate a top dimension of a conductor portion in an electrical circuit;
a bottom dimension calculator operative to calculate a bottom dimension of a conductor in an electrical circuit; and
a cross section configuration analyzer operative to receive top dimension calculations for a multiplicity of conductor portions, and bottom dimension calculations for said multiplicity of conductor portions and output a report of said top dimensions and said bottom dimensions.

23. An electrical circuit inspection method comprising:
inspecting at least one conductor to provide cross sectional information of a conductor; and
employing said cross-sectional information to provide output data indicative of the impedance of said conductor.

24. An electrical circuit inspection method according to claim 23 and wherein said inspecting comprises:
sensing reflectivity of said conductor; and
sensing luminescence of a substrate in a vicinity of said conductor.

25. Electrical circuit inspection method comprising:
calculating, at a plurality of sampling points, a surface dimension of a conductor portion in an electrical circuit;
calculating, at said plurality of sampling points, a footprint dimension of said conductor portion in said electrical circuit;
analyzing said surface dimensions and said footprint dimensions for said plurality of sampling points; and
outputting a report based on said surface dimensions and said footprint dimensions.

26. A method for manufacturing an electrical circuit, comprising:
using equipment to provide a printed circuit board having at least one conductor on a substrate;
inspecting said printed circuit board to obtain a surface dimension value corresponding to a surface dimension of said at least one conductor;
inspecting said printed circuit board to obtain a footprint dimension value corresponding to a footprint dimension of said at least one conductor; and
adjusting said equipment based on one or more of said surface dimension value and said footprint dimension value.

27. A method for manufacturing an electrical circuit, comprising:
forming at least one conductor on a substrate to provide a printed circuit board;
inspecting said printed circuit board to obtain cross-section information for said at least one conductor;
making a production determination based on said cross-section information.

28. The method for manufacturing an electrical circuit as set forth in claim 27, wherein said production determination is one of:
approving said printed circuit board;
discarding said printed circuit board; and
repairing said circuit board.

29. The method for manufacturing an electrical circuit as set forth in claim 27, wherein said cross-section information includes a surface dimension and a footprint dimension of said at least one conductor.
